(19) United States
(12) Patent Application Publication
(10) Pub. No.: US 2006/0005408 A1
(43) Pub. Date: Jan. 12, 2006

(54) Multipurpose angle measurement tool

(76) Inventor: Roy Fernand, Thetford-Mines (CA)

Correspondence Address: INVENTARIUM, Suite 1607, 4050 Rosemont Blvd., Montreal, QC, H1X 1M4, CA

(21) Appl. No.: 11/176,150

(22) Filed: Jul. 7, 2005

Related U.S. Application Data
(60) Provisional application No. 60/585,810, filed on Jul. 7, 2004.

(51) Int. Cl. B43L 7/00

(52) U.S. Cl. 33/471

(57) ABSTRACT

A multipurpose angle measurement tool generally comprises a top ruler and a bottom ruler which are rotationally attached to each other. Both the top and bottom rulers have both metric and american measurement indicias. The top ruler has a vernier window through which are seen degree angles. A tightening knob controls a tightening means which allows the possibility of selectively choosing whether the two rulers should be locked in a given configuration or allowed to freely move relative to each other such as when indicating deviation from the horizontal or the vertical by letting one of the rulers (top or bottom) swing as a pendulum and be stopped by gravity.

### BACKGROUND OF THE INVENTION

1. Field of the Invention

The invention relates generally to hand tools but more particularly to a tool used for measuring dimensions as well as angles for various purposes.

2. Background of the Invention

Many inventions exist in this field and each has some lacking features found on other inventions, the reason being that a particular design is not suitable for combining all features into a single embodiment unless an unobvious way is found for combining several features.

### SUMMARY OF THE INVENTION

In view of the foregoing disadvantages inherent in the known devices now present in the prior art, the present invention, which will be described subsequently in greater detail, is to provide objects and advantages which are:

To include a ruler which can fold to become an angle protractor with a vernier means for precisely indicating an angle.

To have indicias giving information for cutting mouldings and calculating roof slopes.

To have the ability to indicate deviation from the horizontal or the vertical by way of a pendulum.

To receive accesories to become a compass for drawing circles.

To be used as a cutting guide because of its rigid and straight structure.

To attain these ends, the present invention generally comprises a top ruler and a bottom ruler which are rotationally attached to each other. Both the top and bottom rulers have both metric and american measurement indicias. The top ruler has a vernier window through which are seen degree angles. A tightening knob controls a tightening means which allows the possibility of selectively choosing whether the two rulers should be locked in a given configuration or allowed to freely move relative to each other such as when indicating deviation from the horizontal or the vertical by letting one of the rulers (top or bottom ) swing as a pendulum and be stopped by gravity.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

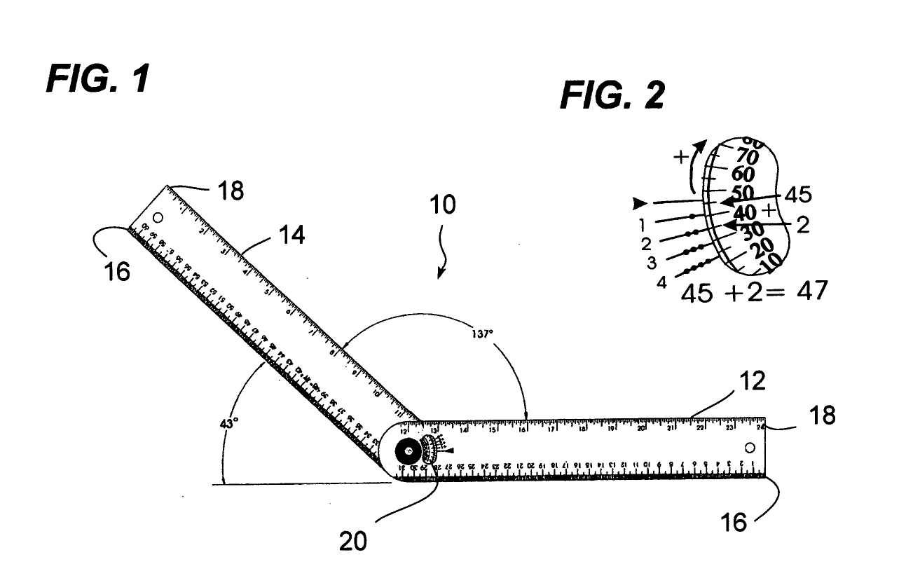

FIG. 1 Plan view of the measurement tool.

FIG. 2 Detail plan fiew of the vernier window.

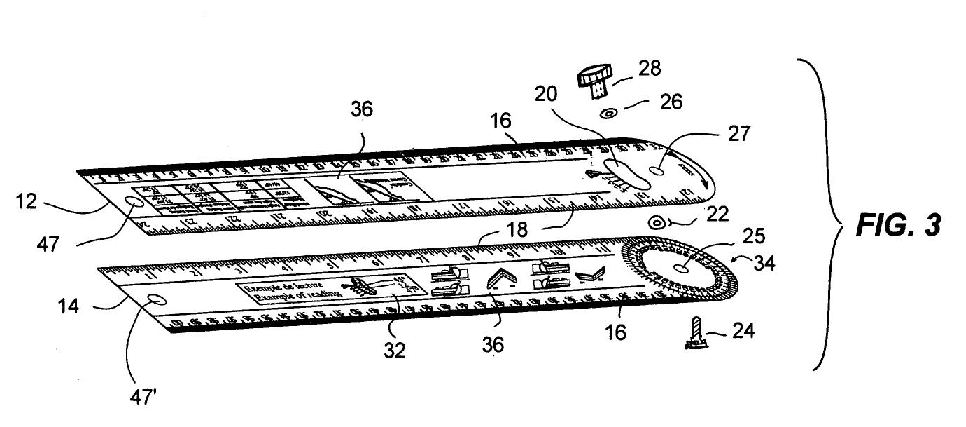

FIG. 3 Perspective exploded view of the measurement tool.

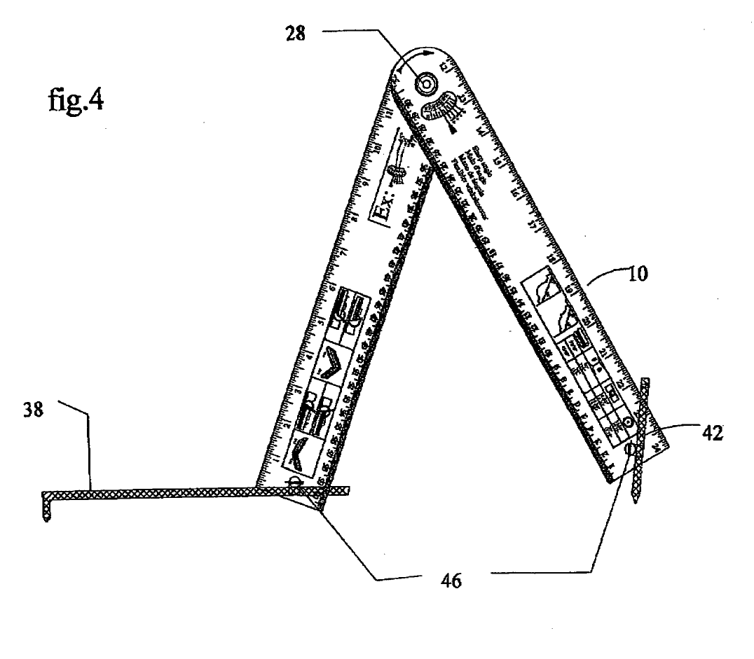

FIG. 4 Plan view of the measurement tool in drawing compass mode.

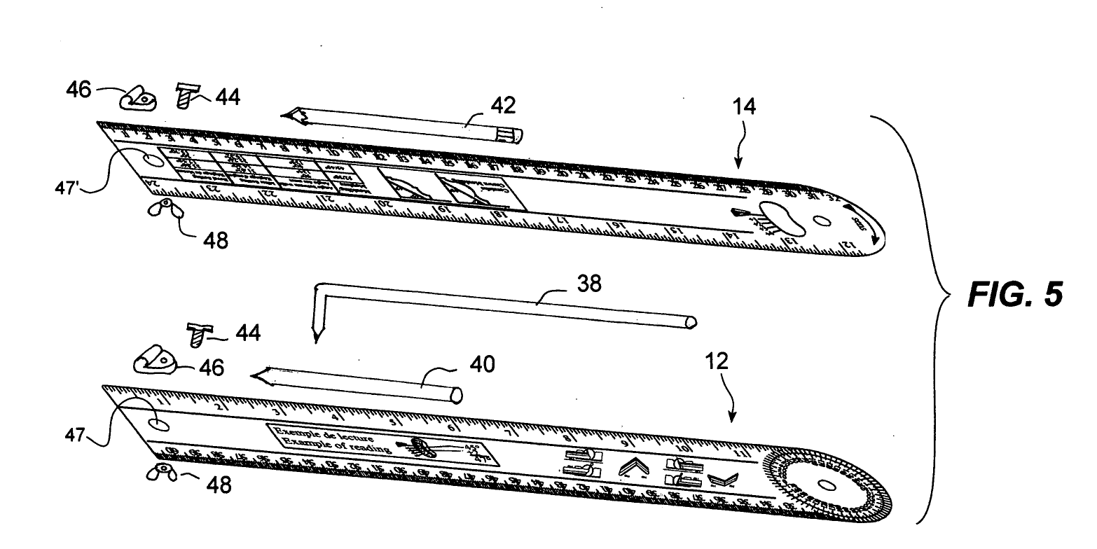

FIG. 5 Perspective exploded view of the measurement tool with drawing compass accessories.

### DETAILED DESCRIPTION OF THE PREFERRED EMBODIMENT

A multipurpose angle measurement tool (10) has a top ruler (12) and a bottom ruler (14) which are rotationally attached to each other. Both the top and bottom rulers (12, 14) have metric measurement indicias (16) and american measurement indicias (18). The top ruler (12) has a vernier window with indicias (20) through which are seen degree angles (34), situated on the bottom ruler (14) which can be precisely measured using the well known vernier principle. To rotationally attach the top and bottom rulers (12, 14), a tightening knob (28) acting as a tightening means controls rotational movement between the top ruler (12) and the bottom ruler (14). A threaded bolt (24) passes through a bottom ruler hole (25), a low friction washer (22), a top ruler hole (27), a washer (26), and, finally, the tightening knob (28) which allows the possibility of selectively choosing whether the two rulers (12, 14) should be locked in a given configuration or allowed to freely rotationally move relative to each other such as when indicating deviation from the horizontal or the vertical (depending upon one's point of reference) by letting one of the rulers, top or bottom (12, 14), swing as a pendulum and stop by gravity into a vertical position. This pendulum action is akin to the action of a plumb bob. Both the top ruler (12) and the bottom ruler (14) have indicias for indicating things such as a cutting angles guide (36) and vernier use instructions (32).

To convert into drawing compass mode, clips (46), wingnuts (48), and wingnut bolts (44), are added to the multipurpose angle measurement tool (10) by passing the wingnut bolts (44) through a pair of drawing compass holes (47, 47′) wherein one said drawing compass hole (47) being in said top ruler (12) and said other drawing compass hole (47′) being in said bottom ruler (14) and said clips (46) holding a writing implement (42) such as a pen, pencil or marker; a pointy stake (40), or an angled stake (38) used as per FIG. 4 in which, by varying the angle between each of the top and bottom rulers (12, 14), the circumference of the drawn circle can be changed. The angled stake (38) allows for larger circles to be drawn.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A multipurpose angle measurement tool comprising:
a top ruler and a bottom ruler and said top ruler and said bottom ruler being in a rotational relation;
a tightening means to selectively allow movement or block movement of said top ruler and said bottom ruler in their rotational relation;
a means for changing said multipurpose angle measurement tool into a drawing compass;
a means for changing said multipurpose angle measurement tool into a plumb bob;
a series of markings for instructions.

2. A multipurpose angle measurement tool as in claim 1 wherein:
in combination, clips, wingnuts, and wingnut bolts are installed onto said multipurpose angle measurement tool by passing said wingnut bolts through a pair of drawing compass holes wherein one said drawing compass hole being in said top ruler and said other drawing compass hole being in said bottom ruler and said clips holding a writing implement, a pointy stake, or an angled stake, so that said multipurpose angle measurement tool can be used as a drawing compass.

3. A multipurpose angle measurement tool as in claim 1 wherein:
said top ruler and said bottom ruler having metric measurement indicias and american measurement indicias;

4. A multipurpose angle measurement tool as in claim 1 wherein:
said top ruler having a vernier window to see degree angles situated on said bottom ruler;

5. A multipurpose angle measurement tool as in claim 1 wherein:
said markings comprising metric and american measurement indicias, vernier instructions, and cutting angles guide.

6. A multipurpose angle measurement tool as in claim 1 wherein:
said tightening means being, in combination, a threaded bolt passing through a bottom ruler hole, a low friction washer, a top ruler hole, a washer, and a tightening knob so as to rotationally attach said top and said bottom rulers;
said threaded bolt allowing the possibility of selectively putting said top and bottom rulers in a locked position or unlocked configuration allowing rotational relation between said top ruler and said bottom ruler.

7. A multipurpose angle measurement tool as in claim 1 wherein:
said multipurpose angle measurement tool being used as a drawing compass when combining clips, wingnuts, and wingnut bolts passing through drawing compass holes for holding a writing implement, a pointy stake, or an angled stake,

8. A multipurpose angle measurement tool used as a plumb bob by using the following method:
allowing free rotational movement between said said top ruler and said bottom ruler so that one of said rulers indicating deviation from the horizontal or the vertical by letting one of the rulers swing as a pendulum until stopped by gravity into a vertical position.

9. A multipurpose angle measurement tool used as a drawing compass by using the following method:
install clips, wingnuts, and wingnut bolts through drawing compass holes situated on a top ruler and a bottom ruler;
put a writing implement in one of said clip and put a pointy stake or an angled stake in the other said clip;
by varying the angle between each said top ruler and said bottom ruler, the circumference of a drawn circle can be changed.
